(19) United States
(12) Patent Application Publication
(10) Pub. No.: US 2007/0060151 A1
(43) Pub. Date: Mar. 15, 2007

(54) Power Line Communication System

(75) Inventor: William Chen-Yu Lee, Taipei (TW)

Correspondence Address: LAW OFFICES OF LAI & ASSOCIATES, P.C., 5800 RANCHESTER, STE. 200, HOUSTON, TX, 77036, US

(73) Assignee: HUITAI DEVELOPMENT CORPORATION, Taipei (TW)

(21) Appl. No.: 11/307,518

(22) Filed: Feb. 10, 2006

Related U.S. Application Data
(60) Provisional application No. 60/715,165, filed on Sep. 9, 2005.

(51) Int. Cl. H04Q 7/20

(52) U.S. Cl. 455/446

(57) ABSTRACT

A power line communication system is applied in a building and a plurality of power lines is laid in the building. Alternating current and at least a power line communication signal can be transmitted via the plurality of power lines. The power line communication system comprises at least a wireless remote control apparatus, at least a communication equipment and at least a power supply module. At least a wireless signal is transmitted by the at least a wireless remote control apparatus to the at least a communication equipment by using a wireless transmission protocol. The at least a communication equipment is combined with the building for receiving the at least a wireless signal. The at least wireless signal is then transformed into a power line communication signal and the power line communication signal is then transmitted to the at least a power supply module via the plurality of power lines. The at least a power supply module is electrically connected to ends of the plurality of power lines to receive the power line communication signal in order to execute a corresponding action.

### FIELD OF THE INVENTION

The present invention relates to a power line communication system and, more particularly, to a plurality of power lines electrically connecting a communication equipment and a power supply module in a building for controlling the power supply module.

### BACKGROUND OF THE INVENTION

Power Line Communication (PLC) is a path to provide a two-way communications. At least a power line which transmits alternating current is utilized to accomplish high resolution video transmission and VoIPs. Currently, the power line communication has been applied in connecting computers and various electronic products. The easy-to-use and the stabilization also increasingly grow up. The power line communication is provided with certification and encryption to ensure the security and the reliability for the communication.

An Institute of Electrical and Electronics Engineers (IEEE) P1901 for the power line communication is established to enable high speed communication equipments to combine with the at least a power line. The above-described standard is applied in a building which carries various equipments with cooper power lines for transmitting in order to generate an information channel of a Broadband Power Line (BPL) with balance and high efficiency. The information channel can meet the demand of bandwidth for users and quality of service (QoS); hence the capability for the power line transmitting signals attracts much attention. A socket having alternating current can be transformed into communication ports without laying network cables.

Referring to FIG. 1, a schematic diagram illustrates a conventional control system for intelligence home appliances. A television (TV) is set to be a control interface and the at least a power line is set to be a medium for controlling various intelligence home appliances. The control system for the intelligence home appliance comprises a TV 11, a server 12, a communication control module 13 and a plurality of intelligence home appliances 14. The TV is connected to at least a power line. A display panel and a user interface are set on the TV 11 to provide a user to implement a control action. The server 12 is utilized to process at least a control command inputted from the user interface in order to control work schedules of the plurality of intelligence home appliances 14. The communication control module 13 is a communication bridge between the server 12 and the plurality of intelligence home appliances 14. The at least a control command is transmitted by at least a power line 15 to the plurality of intelligence home appliances 14 for controlling the plurality of intelligence home appliances 14.

By the way mentioned above, the goal of applying power lines to control the control system for intelligence home appliances can be achieved. However, those intelligence home appliances are too expensive that can not be applied everywhere. The upgrade for home appliances can be solved if sockets are integrated.

### SUMMARY OF THE INVENTION

Briefly, the object of the present invention is to meet the demand of using power lines to be networks by providing a power line communication system which lays a plurality of power lines in a building. Alternating current and at least at least a power line communication signal can be further transmitted by the plurality of power lines.

In order to achieve the above goal, the power line communication system is applied in the building and comprises at least a wireless remote control apparatus, at least a communication equipment and at least a power supply module. A wireless transmission protocol is utilized in the wireless remote control apparatus for transmitting at least a wireless signal to the communication equipment The communication equipment is combined with the building and comprises at least a wireless receiver, at least a memory unit, at least a processor and at least a transmitter. The wireless transmission protocol is utilized by the at least a wireless receiver to receive the at least a wireless signal sent from the at least wireless remote control apparatus. At least a correspondence data is stored in the at least a memory unit. The at least a correspondence data comprises at least a parameter for decoding and at least a parameter for controlling a transmission path. The at least a wireless signal is processed by the at least a processor based on the at least a correspondence data to generate a command and to control the at least a transmitter. The command is then transformed by the at least a transmitter into a power line communication signal which can be transmitted by the plurality of power lines. The power line communication signal is then transmitted to the at least a power supply module via the plurality of power lines. The at least a power supply module is electrically connected to ends of the plurality of power lines for providing alternating current. The power line communication signal sent by the at least a transmitter is received via the plurality of power lines to execute a corresponding action. The corresponding action can be used to disable or enable to provide alternating current.

Other features and advantages of the present invention and variations thereof will become apparent from the following description, drawings, and claims.

### BRIEF DESCRIPTION OF THE DRAWINGS

FIG. 1 is a schematic diagram of a conventional control system for intelligence home appliances combining with a power line;

FIGS. 2, 3 and 4 are schematic diagrams of a power line communication system according to embodiments of the present invention;

FIGS. 5 and 6 are flowcharts of a method for a power line communication according to embodiments of the present invention; and

FIG. 7 is a schematic diagram of a wireless remote control apparatus according to an embodiment of the present invention.

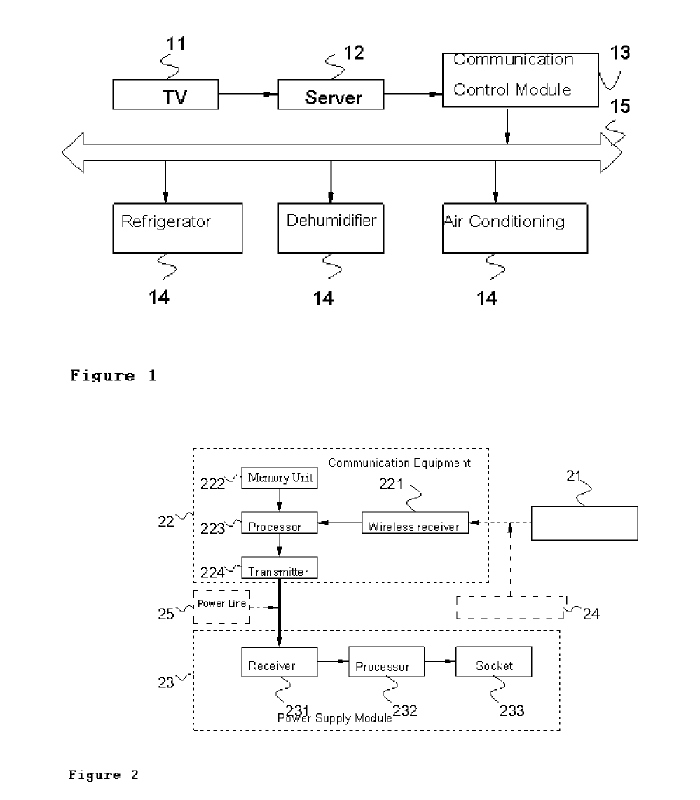

### DETAILED DESCRIPTION OF THE PREFERRED EMBODIMENTS

To make it easier for understanding the objective of the invention, its innovative features and performance, a detailed description and technical characteristics of the power line communication system are described together with the drawings as follows.

Referring to FIG. 2, a schematic diagram illustrates a power line communication system according to an embodiment of the present invention. The power line communication system comprises at least a wireless remote control apparatus 21, at least a communication equipment 22 and at least a power supply module 23. At least a wireless receiver 221, at least a memory unit 222, at least a processor 223 and at least a transmitter 224 are integrated into the at least a communication equipment 22. The at least a wireless remote control apparatus 21 is controlled by a user by using a wireless transmission protocol 24 for transmitting at least a wireless signal to the at least wireless receiver 221 of the at least a communication equipment 22. The at least a wireless remote control apparatus 21 is usually a portable apparatus. The wireless transmission protocol 24 can be a Bluetooth protocol, an infrared protocol, or an Institute of Electrical and Electronics Engineers (IEEE) 802a, 802b and 802g security protocols. The at least a communication equipment 22 is combined with a building and the at least a wireless signal sent by the at least a wireless remote control apparatus 21 is received by using the wireless transmission protocol 24. A plurality of power lines 25 are electrically connected to the at least a power supply module 23. The wireless transmission protocol 24 is utilized by the at least a wireless receiver 221 to receive the at least a wireless signal sent by the at least a wireless remote control apparatus 21. The at least a wireless signal is further transmitted to the at least a processor 223. At least a correspondence data is stored in the at least a memory unit 222. The at least a correspondence data comprises at least a parameter for decoding and at least a parameter for controlling a transmission path. The at least a wireless signal is processed by the processor 223 for decoding and comparing in order to determine the contents of the at least a wireless signal and the transmission path and thereby generate a command. The command is transmitted to the at least a transmitter 224 for controlling the transmission path of the at least a transmitter 224. The command is then transformed into a power line communication signal which can be transmitted by the plurality of power lines 25 after the command is received by the at least a transmitter 224. The power line communication signal is then transmitted to the at least a power supply module 23. It should be noted that the plurality of power lines 25 is a prior art and is not the point of the present invention. The at least a power supply module 23 comprises at least a receiver 231, at least a processor 232, and at least a socket 233. The at least a power supply module 23 is combined with the building and is electrically connected to ends of the plurality of power lines 25. The power line communication signal is received by the at least a receiver 231 through the plurality of power lines 25. The at least a socket 233 is controlled by the at least a processor 232 based on the power line communication signal to execute a corresponding action which is corresponded to the at least a wireless signal. For example, the corresponding action can be used to disable or enable to provide alternating current.

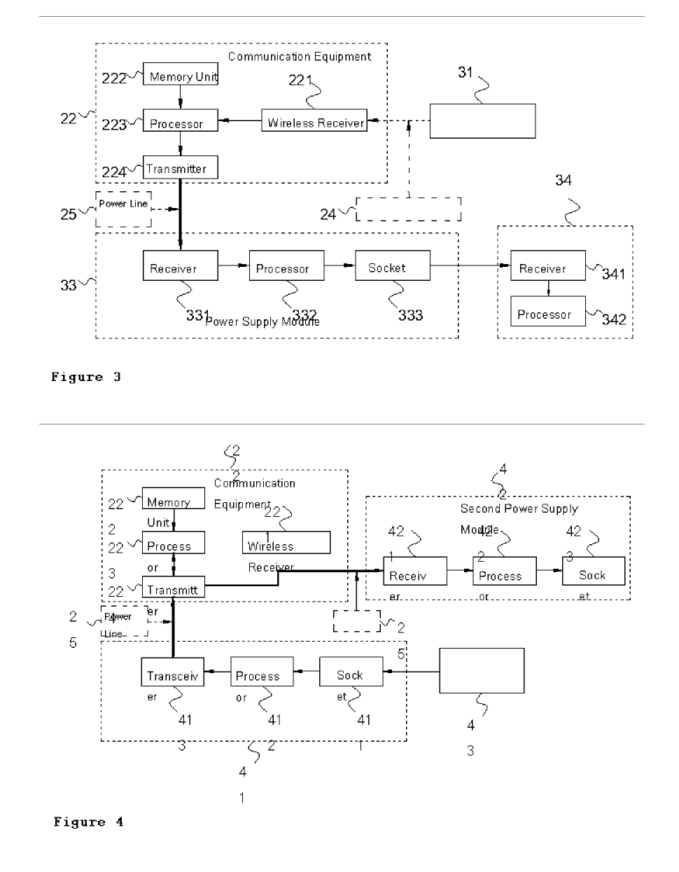

Referring to FIG. 3, a block diagram illustrates the power line communication system according to another embodiment of the present invention. The power line communication system comprises a wireless remote control apparatus 31, the at least a communication equipment 22 and at least a power supply module 33. The at least a wireless receiver 221, the at least a memory unit 222, the at least a processor 223 and the at least a transmitter 224 are integrated into the at least a communication equipment 22. The at least a power supply module 33 comprises at least a receiver 331, at least a processor 332 and at least a socket 333. The wireless remote control apparatus 31 is controlled by a user and the wireless transmission protocol 24 is used to transmit the at least a wireless signal to the at least a wireless receiver 221 of the at least a communication equipment 22. The at least a wireless remote control apparatus 21 is usually a portable apparatus. The wireless transmission protocol 24 can be a Bluetooth protocol or an infrared protocol. The at least a communication equipment 22 is combined with the building by using the wireless transmission protocol 24 to receive the at least a wireless signal sent from the wireless remote control apparatus 31. The plurality of power lines 25 are electrically connected to the at least a power supply module 33. The at least a wireless signal sent from the wireless remote control apparatus 31 is received by the at least a wireless receiver 221 by using the wireless transmission protocol 24. The at least a wireless signal is then transmitted to the at least a processor 223. The at least a correspondence data is stored in the at least a memory unit 222. The at least a correspondence data comprises the at least a parameter for decoding and the at least a parameter for controlling the transmission path. The at least a wireless signal is decoded and compared by the at least a processor 223 based on the at least a correspondence data to determine the contents of the at least a wireless signal and the transmission path and thereby generate a command. The command is transmitted to the at least a transmitter 224 for controlling the transmission path of the at least a transmitter 224. The command is transformed into the power line communication signal which can be transmitted by the plurality of power lines 25 after the command sent from the at least a processor 223 is received by the lat least a transmitter 224. The power line communication signal is then transmitted to the at least a power supply module 33. It should be noted that the plurality of power lines 25 is a prior art and is not the point of the present invention. The at least a power supply module 33 is combined with the building and is electrically connected to the ends of the plurality of power lines 25. The power line communication signal is received by the at least a receiver 331 via the plurality of power lines 25. The at least a socket 333 is controlled by the at least a processor 332 based on the power line communication signal to enable the at least a socket 333 to transmit alternating current and the power line communication signal. The at least a socket 333 is electrically connected to the intelligence electronic apparatus 34 for providing alternating current and the power line communication signal to the intelligence electronic apparatus 34. The intelligence electronic apparatus 34 at least comprises a receiver 341 and a processor 342. The power line communication signal is received by the receiver 341 from the at least a socket 333. The power line communication signal is decoded by the processor 342 in order to recover the power line communication signal to be the command. The command can be used to control the intelligence electronic apparatus 34.

Referring to FIG. 4, a block diagram illustrates the power line communication system according to a further embodiment of the present invention. The power line communication system comprises the at least a communication equipment 22, a first power supply module 41 and a second power supply module 42. The at least a wireless receiver 221, the at least a memory unit 222, the at least a processor 223 and the at least a transmitter 224 are integrated into the at least communication equipment 22. The first power supply module 41 comprises a socket 411, a processor 412 and a transceiver 413. The first power supply module 41 is combined with the building and is electrically connected to the ends of the plurality of power lines 25. The socket 411 is electrically connected to an intelligence electronic apparatus 43 to enable the intelligence electronic apparatus 43 to receive alternating current. A power line communication signal of the intelligence electronic apparatus 43 is received by the socket 411. The power line communication signal is a command encoded by the intelligence electronic apparatus 43. The socket 411 is controlled by the processor 412 of the first power supply module 41 based on the power line communication signal to provide alternating current and control the transceiver 413 for transmitting the power line communication signal. The power line communication signal sent from the at least a communication equipment 22 is then received by the transceiver 413 via the plurality of power lines 25. The power line communication signal sent from the intelligence electronic apparatus 43 is also transmitted to the at least a communication equipment via the plurality of power lines 25. It should be noted that the plurality of power lines 25 is a prior art and is not the point of the present invention. The at least a communication equipment 22 is combined with the building and is electrically connected to the first power supply module 41 and the second power supply module 42 via the plurality of power lines 25. The at least a correspondence data is stored in the at least a memory unit 222 of the at least a communication equipment 22. The at least a correspondence data comprises the at least a parameter for Codec (coder-decoder) and the at least a parameter for controlling the transmission path. The power line communication signal of the first power supply module 41 is received by the at least a transmitter 224 of the at least a communication equipment 22 via the plurality of power lines 25 and the power line communication signal is then recovered to the command. The at least a correspondence data is read by the at least a processor 223 of the at least a communication equipment 22 from the at least a memory unit 222. The at least a parameter for controlling the transmission path and the command are utilized for comparing. The transmission path is determined to connect the second power supply module 42. The command is then transmitted to the at least a transmitter 224 to control the transmission path of the at least a transmitter 224. Moreover, the command is transformed by the at least a transmitter 224 into the power line communication signal and the power line communication signal is then transmitted to the second power supply module 42. The second power supply module 42 at least comprises a receiver 421, a processor 422, and a socket 423. The second power supply module 42 is also combined with the building and is electrically connected to the ends of the plurality of power lines 25. The power line communication signal is received by the receiver 421 via the plurality of power lines 25. The socket 423 is controlled by the processor 422 based on the power line communication signal to enable the socket 423 to execute a corresponding action which is corresponded to the command. For example, the corresponding action can be used to disable or enable to provide alternating current.

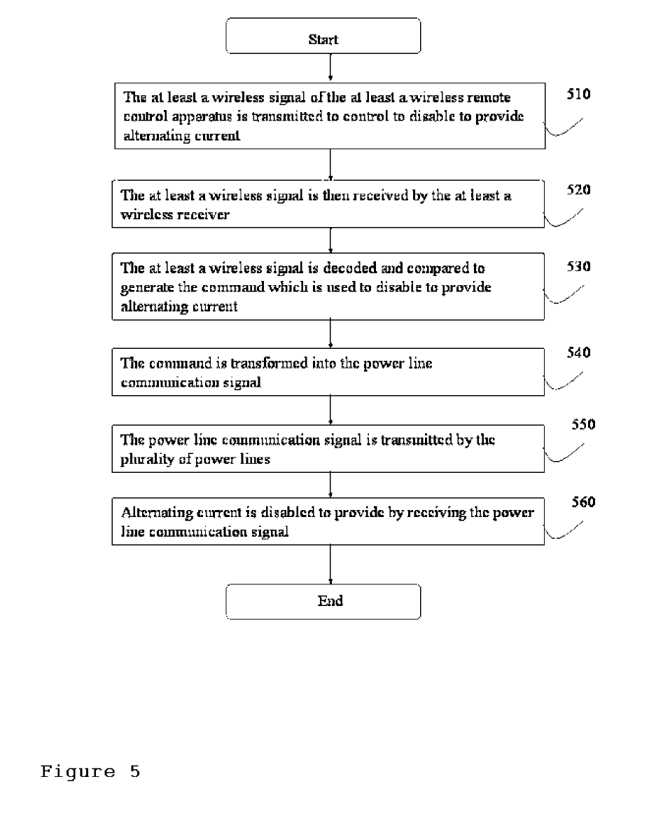

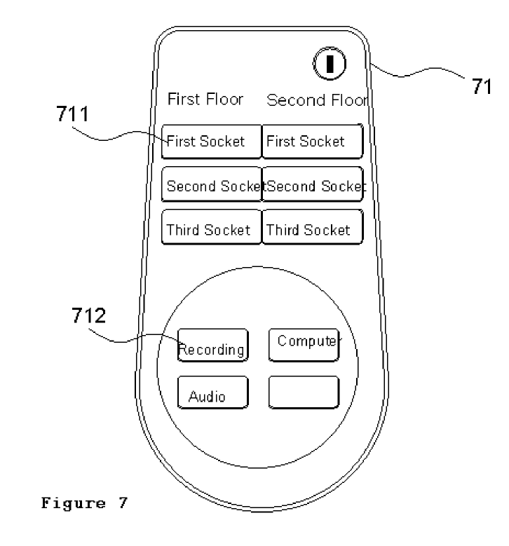

According to the power line communication system, FIG. 5 is a flowchart illustrating a method for a power line communication according to an embodiment of the present invention. FIG. 7 is a schematic diagram illustrating the at least a wireless remote control apparatus according to an embodiment of the present invention.

Step 510: The at least a wireless signal of the at least a wireless remote control apparatus is transmitted to control to disable to provide alternating current.

Step 520: The at least a wireless signal is then received by the at least a wireless receiver.

Step 530: The at least a wireless signal is decoded and compared to generate the command which is used to disable to provide alternating current.

Step 540: The command is transformed into the power line communication signal.

Step 550: The power line communication signal is transmitted by the plurality of power lines.

Step 560: Alternating current is disabled to provide by receiving the power line communication signal.

In the foregoing steps, the at least a wireless remote control apparatus as shown in FIG. 7, when the user presses a first socket key 711 of the at least a wireless remote control apparatus 71, the at least a wireless signal is then sent by the at least a wireless remote control apparatus. The at least a wireless signal is further transmitted by the plurality of power lines to control the first socket to disable power supply and thereby control electronic apparatuses which are electrically connected to the first socket. The at least a wireless remote control apparatus 71 is usually a portable apparatus.

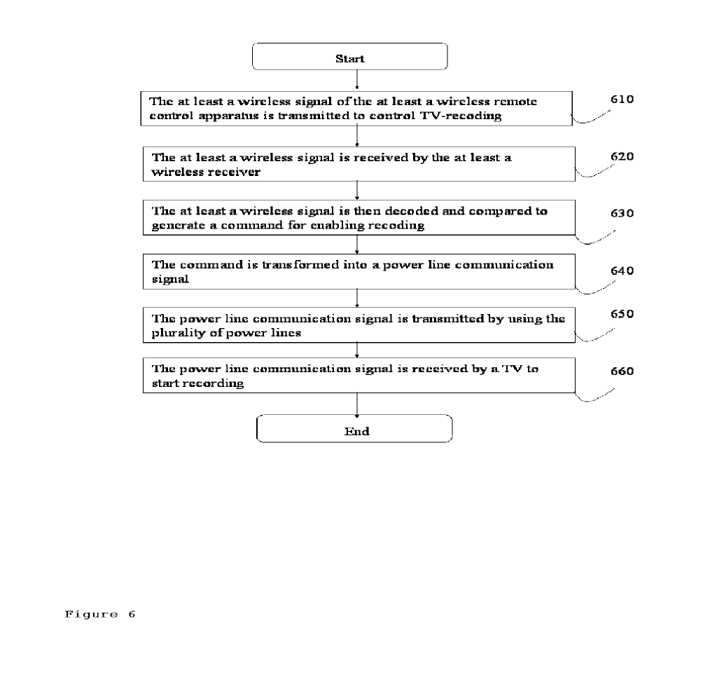

According to the power line communication system, FIG. 6 is a flowchart illustrating the method for a power line communication according to another embodiment of the present invention and please refer to FIG. 7 again.

Step 610: The at least a wireless signal of the at least a wireless remote control apparatus is transmitted to control TV-recoding.

Step 620: The at least a wireless signal is received by the at least a wireless receiver.

Step 630: The at least a wireless signal is then decoded and compared to generate a command for enabling recoding.

Step 640: The command is transformed into a power line communication signal.

Step 650: The power line communication signal is transmitted by using the plurality of power lines.

Step 660: The power line communication signal is received by a TV to start recording.

In the foregoing steps, the at least a wireless remote control apparatus as shown in FIG. 7, when the user presses a recording key 712 of the at least a wireless remote control apparatus 71, the at least a wireless signal is then sent by the at least a wireless remote control apparatus 71 to control the TV. The TV is electrically connected to the plurality of power lines via sockets. The TV is an intelligence electronic apparatus.

Although the features and advantages of the embodiments according to the preferred invention are disclosed, it is not limited to the embodiments described above, but encompasses any and all modifications and changes within the spirit and scope of the following claims.

What is claimed is:

1. A power line communication system, applied in a building, laid a plurality of power lines for transmitting alternating current, comprising:
at least a wireless remote control apparatus for transmitting at least a wireless signal by using a wireless transmission protocol;
at least a communication equipment for combining with the building;
at least a wireless receiver for receiving the at least a wireless signal by using the wireless transmission protocol;
at least a processor for processing the at least a wireless signal based on at least a correspondence data to generate a command;
at least a memory unit for providing the at least a correspondence data to the processor;
at least a transmitter for transforming the command into a power line communication signal, and the transmitter being controlled by the at least a processor to transmit a transmission path of the power line communication signal; and
at least a power supply module for electrically connecting to ends of the plurality of power lines, the power line communication signal being received via the plurality of power lines to execute a corresponding action;
wherein the at least a wireless receiver, the at least a processor, the at least a memory unit, and the at least a transmitter are integrated into the at least a communication equipment.

2. The system of claim 1, wherein the wireless transmission protocol is a Bluetooth protocol.

3. The system of claim 1, wherein the wireless transmission protocol is an infrared protocol.

4. The system of claim 1, wherein the wireless transmission protocol is an Institute of Electrical and Electronics Engineers (IEEE) 802.1x security protocol.

5. The system of claim 1, wherein the wireless remote-controlled apparatus is a portable apparatus.

6. The system of claim 5, wherein the portable apparatus is a Personal Digital Assistant, a mobile phone, or a laptop.

7. The system of claim 1, wherein the power supply module comprises a socket for providing alternating current to an electronic apparatus.

8. The system of claim 7, wherein the electronic apparatus is a refrigerator, a television, an air conditioner, a computer, a microwave oven, or a multifunction printer.

9. The system of claim 7, wherein the socket is disabled based on the power line communication signal to provide alternating current.

10. The system of claim 7, wherein the socket is enabled based on the power line communication signal to provide alternating current.

11. The system of claim 7, wherein the electronic apparatus is an intelligent electronic apparatus controlled by the power line communication signal.
